(19) United States
(12) Patent Application Publication
(10) Pub. No.: US 2007/0223253 A1
(43) Pub. Date: Sep. 27, 2007

(54) Lighting Unit and Liquid Crystal Display Using This

(75) Inventors: Toyohiro Sakai, Tottori (JP); Toshiya Nishio, Tottori (JP)

Correspondence Address: SoCAL IP LAW GROUP LLP, 310 N. WESTLAKE BLVD. STE 120, WESTLAKE VILLAGE, CA, 91362, US

(73) Assignees: Sanyo Electric Co., Ltd., Osaka (JP); Tottori Sanyo Electric CO., Ltd., Tottori (JP)

(21) Appl. No.: 10/599,455

(22) PCT Filed: Mar. 14, 2005
(86) PCT No.: PCT/JP05/04475

§ 371 Date: Sep. 28, 2006

(30) Foreign Application Priority Data
Mar. 30, 2004 (JP) 2004-097362

(51) Int. Cl. F21V 8/00

(52) U.S. Cl. 362/624

(57) ABSTRACT

A lighting unit and a liquid crystal display unit using this, comprising a housing having a rectangular bottom wall surface and formed respectively at a pair of facing side edges thereof with locking projections projecting from the bottom wall surface, a reflection sheet having locking portions locked with the respective locking projections, and a light guide plate laminated on the reflection sheet and having locking portions locked with the locking projections, wherein the locking projections are formed on the center lines X-X connecting the center points of the sides, where no light sources are formed, of the light guide plate, and the locking portions of the reflection sheet and the light guide plate are locked with these locking projections and fixed, thereby providing a lighting unit having the reflection sheet fixed so as to be wrinkle-free, and a liquid crystal display unit using this.

### TECHNICAL FIELD

The present invention relates to a lighting unit that has a reflection sheet that is fixed in such a manner as to prevent wrinkle, etc., and to a liquid crystal display using this unit.

### BACKGROUND ART

Possessing the features of being low power consuming, lightweight and space saving compared to other displays, liquid crystal displays are widely used as displays for cellular telephones, personal computers, car navigation systems, televisions, and various kinds of business machines.

But as such equipment becomes each year progressively more multifunctional, high performance, convenient and low cost, these displays are being required to be even higher quality, even less power consuming, and even more lightweight, space saving and low cost.

In order to realize a bright display picture, these liquid crystal displays are usually fitted with a lighting unit equipped with a light source of various kinds, light being shone through the back of a liquid crystal panel by means of such lighting unit. The lighting units are broadly divided into two differing types according to the position where the light source is installed: an edge light type in which a linear light source is deployed along a side edge of the light guide plate, and a bottom light type in which a light source is deployed on the reverse face of the light guide plate.

The edge light type is employed in liquid crystal displays that prioritize thinness, because of this type's superior thinness and the uniformity of brightness of its light-emitting surface, while the bottom light type is employed in liquid crystal displays that require a high degree of brightness, since this type permits deployment of a large-size light source.

FIG. 8 is a cross-section of an example of the well-known edge light type lighting unit. This lighting unit UT1 is composed of a light guide plate 101 that illuminates a liquid crystal panel, and a reflection sheet 103 that reflects toward the liquid crystal panel the light from fluorescent discharge tubes 102 deployed along the reverse face of the light guide plate 101.

The reflection sheet 103's portions 103a, which are located around the fluorescent discharge tubes 102, are kept separate from the reflection sheet 103's portion 103b, which is located on the reverse face of the light guide plate 101, the two being bonded by double-sided tape 107a, 107b or other adhesive. The portions 103a are bent into a U-shape so as to enclose the fluorescent discharge tubes 102 and are fixed in the vicinity of the fluorescent discharge tubes 102 by double-sided tape 107a, 107b.

However, when the light guide plate 101 and the reflection sheet 103 are bonded by double sided tape on the reverse face of the light guide plate 101 as in the lighting unit UT1, the differences in the thermal expansion coefficients and water absorption coefficients of the light guide plate 101 and reflection sheet 103 will produce a difference in the amounts of expansion and contraction with changes in the temperature and humidity in the lighting unit's surroundings, so that flexure will occur in the reflection sheet 103, and such flexure may be reflected as uneven brightness in the light-emitting surface at the outward face of the lighting unit. In particular, a minute flexure or wrinkle of the reflection sheet 103 in the K1 region close to the fluorescent discharge tube 102 at the reverse face may manifest as uneven brightness in the light-emitting surface. With the use of a film-like reflection sheet 103 in recent times, such flexure or wrinkle has become particularly liable to occur.

Various lighting units that resolve this issue have been developed, as a specific example of which is now described the lighting unit set forth in Patent Document 1 below. FIG. 9 is a cross-sectional view showing the lighting unit described in Patent Document 1 below. This lighting unit UT2 is composed of a light source 112; a light guide plate 111 that is deployed in proximity to the light source 112 and guides the light from the light source 112 so as to illuminate a liquid crystal panel; a first reflection sheet 113A deployed to lie over the reverse face of the light guide plate 111; and a second reflection sheet 113B that is deployed between the light guide plate 111 and the first reflection sheet 113A and reflects light emitted from the light source 112.

The second reflection sheet 113B is not fixed by bonding or similar to the light guide plate 111 nor to the first reflection sheet 113A, but is fixed by being held between the light guide plate 111 and the reflection sheet 113A.

According to the lighting unit UT2, one of the reflector 115 ends is bonded to the first reflection sheet 113A by double-sided tape 117b and the second reflection sheet 113B is deployed between the light guide plate 111 and the first reflection sheet 113A, a location free from the influence of the bonding, so that even if flexure or wrinkle occurs in the first reflection sheet 113A, the light guided through the light guide plate 111 will be reflected by the second reflection sheet 113B, and hence no uneven brightness will occur.

Flexure and wrinkle occur in the well-known lighting unit UT1 because the end portion of the reflection sheet is fixed with adhesive. In the lighting unit UT2 there is no occurrence of flexure or wrinkle in the second reflection sheet because this reflection sheet is not fixed, but flexure and wrinkle are prone to occur in the first reflection sheet 113A because first reflection sheet 113A is fixed with double-sided tape 117b, and when such flexure or wrinkle occurs there is risk that it will exert effects on the second reflection sheet 113B. Further, since the two reflection sheets form a set and must be fixed with double-sided tape, the number of parts is large and the installation is troublesome.

A particular difficulty is that the higher definition the liquid crystal display is, the smaller the size of its individual pixels will be and the higher the proportion of each pixel that will be occupied by wiring, etc., with the result that the pixel's open area ratio will be lowered. In order to compensate for the decrease in brightness that accompanies lowering of the open area ratio, high definition liquid crystals are often seen in which light sources are deployed at both side edges of the light guide plate, rather than a light source being deployed on one side edge only. But in proportion as light sources are deployed at both side edges, the heat from the light sources increases, rendering flexure more prone to occur in the reflection sheets. Hence, when the structure disclosed in Patent Document 1 or 2 below is employed, the foregoing problem will manifest even more markedly.

Patent Document 1

Japanese Laid-Open Patent Publication No. 2002-279814 (FIG. 4, FIG. 6 [0038]-[0041])

### DISCLOSURE OF INVENTION

### Problems to be Solved by the Invention

The present invention was made in order to solve the problems with the above prior art technology. That is, the purpose of the present invention is to provide, for a liquid crystal display of the type that deploys light sources at both side edges of the light guide plate, a lighting unit that curbs the occurrence of wrinkle in the reflection sheet, and to provide also a liquid crystal display that uses such lighting unit.

### MEANS TO RESOLVE THE PROBLEMS

The lighting unit of claim 1 of the present invention is equipped with:

a housing having a rectangular bottom wall, wherein a locking projection that projects from the bottom wall is formed respectively at a pair of facing side edges of the housing;

a reflection sheet having locking portions that lock with the locking projections;

a light guide plate that is laminated over such reflection sheet and has locking portions that lock with the locking projections; and

light sources deployed at both ends of the light guide plate.

This lighting unit has the innovative feature that the locking projections are formed on the center line that connects the center points of those of the light guide plate's edges on which no light source is deployed.

The present invention relating to claim 2 is the lighting unit of claim 1 with the further feature that the locking projections consist of linear projections of a particular length that are parallel to the facing side edges.

The present invention relating to claim 3 is the lighting unit of claim 2 with the further feature that one of the opposed linear projections is longer than the other.

The present invention relating to claim 4 is the lighting unit of any of claims 1 to 3 with the further feature that the longitudinal center point of one of the opposed locking projections lies on said center line, while the other locking projection is formed with its longitudinal center point in a position removed from the center line.

The liquid crystal display of claim 5 of the present invention has the innovative feature of being equipped with the lighting unit of any of claims 1 to 4 and with a liquid crystal panel that is located on the irradiating surface side of the lighting unit.

### EFFECTS OF THE INVENTION

According to claim 1 of the present invention, the reflection sheet is fixed via locking projections that are provided on the center line connecting the center points of those of the edges of the housing's light guide plate on which no light source is deployed, thanks to which the locking projections will not inhibit any expansion/contraction of the reflection sheets due to heat from the light sources provided close to the periphery of the light guide plate. Hence if the reflection sheet expands, for example, the reflection sheet will not develop any wrinkle due to being fixed via the projections. In this way a lighting unit can be provided that does not have any uneven brightness in its light-emitting surface.

According to claim 2 of the present invention, the locking projections are linear projections, thanks to which the locking projections can be formed simply by making cuts in the housing and turning inward the resulting cutout portions. Thus the locking projections can be formed in a simple manner without the need to be provided in advance when the housing is molded.

According to claims 3 and 4 of the present invention, the locking projections are provided in such a manner that their lengths and positions differ, which eliminates any mistakes in the installation orientations when the reflection sheet and light guide plate are installed.

According to claim 5 of the present invention, a lighting unit yielding the beneficial effects of claims 1 to 4 is used as a liquid crystal display, thus providing a liquid crystal display that is free from uneven brightness.

### BRIEF DESCRIPTION OF THE DRAWINGS

FIG. 1 is a plan view illustrating the lighting unit of the liquid crystal display of the present invention.

FIG. 2 is a perspective view of the housing and chassis in FIG. 1 seen from the bottom.

FIG. 3 is a plan view illustrating the housing.

FIG. 4 is a perspective view illustrating the reflection sheet, light guide plate and optical sheets.

FIG. 5 is a cross-sectional view on A-A in FIG. 1.

FIG. 6 shows side edges of the liquid crystal display; FIG. 6A is an enlarged cross-sectional view of portion C in FIG. 5, and FIG. 6B is an enlarged cross-sectional view of portion D in FIG. 5.

FIG. 7 is a plan view illustrating the reflection sheet installed in the housing.

FIG. 8 is a cross-sectional view illustrating an example of the well-known edge light type lighting unit.

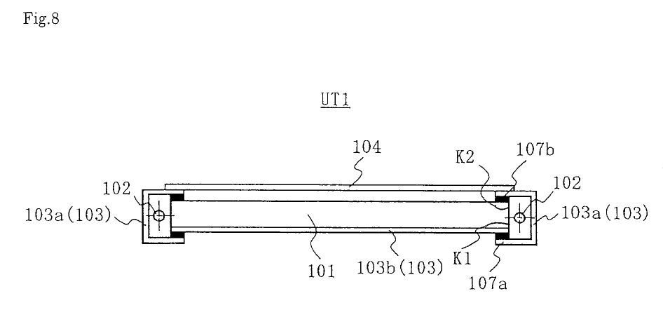

FIG. 9 is a cross-sectional view illustrating the lighting unit set forth in Patent Document 1.

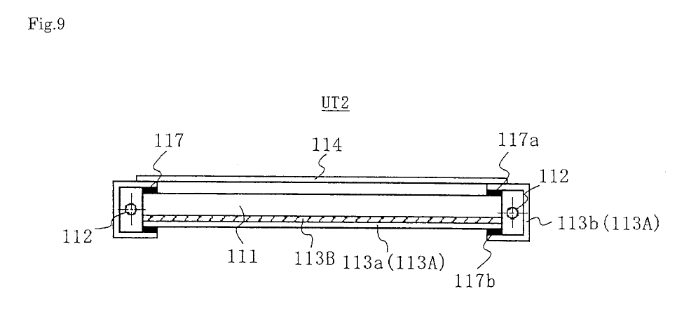

### REFERENCE NUMERALS

11 Housing
12 Bottom wall
13₁-13₄ Sidewalls
14₁-14₄ Cutout tabs (locking projections)
15₁ Locking opening
20 Reflection sheet
20₁, 20₂ Flat-bottomed notches (locking portions)
21 Light guide plate
21₁, 21₂Flat-bottomed notches (locking portions)
22a-22c Optical sheets
22a₁-22c₂ Flat-bottomed notches
30 Chassis
31₃, 31₄ Sidewalls
32₁ Locking bars
50 Light sources

### BEST MODE FOR CARRYING OUT THE INVENTION

Below, preferred embodiments of the present invention are described with reference to the drawings. However, the embodiments below represent merely illustrative instances of a lighting unit and liquid crystal display using such lighting unit for realizing the technical thought of the present invention; these embodiments are not intended to limit the present invention to this particular lighting unit and liquid crystal display using such lighting unit. The invention can be equally well applied in other embodiments contained in the scope of the claims.

### Embodiment 1

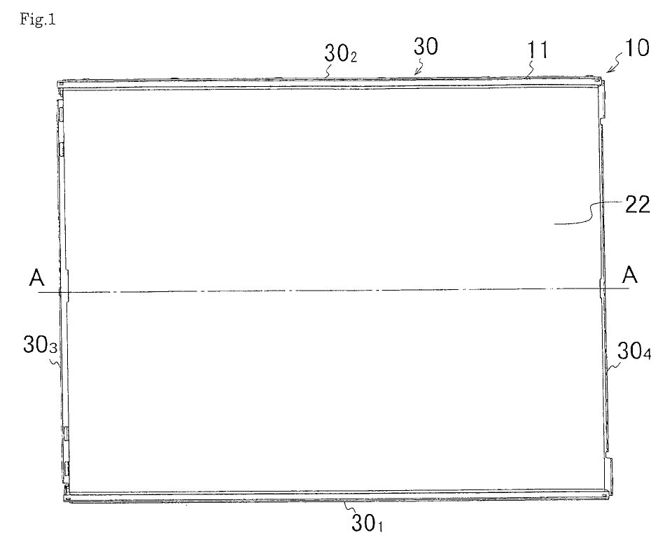

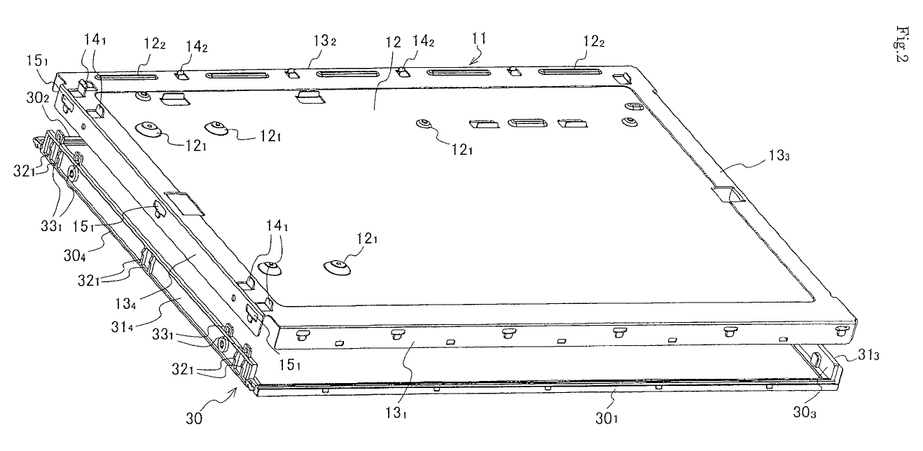

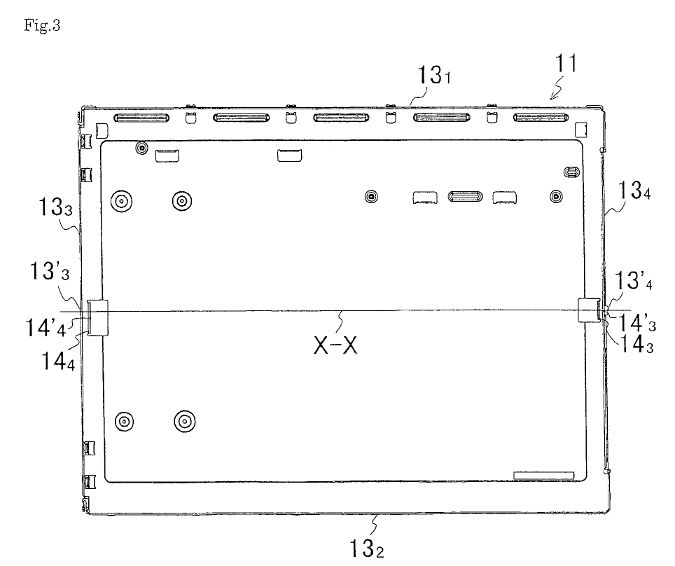

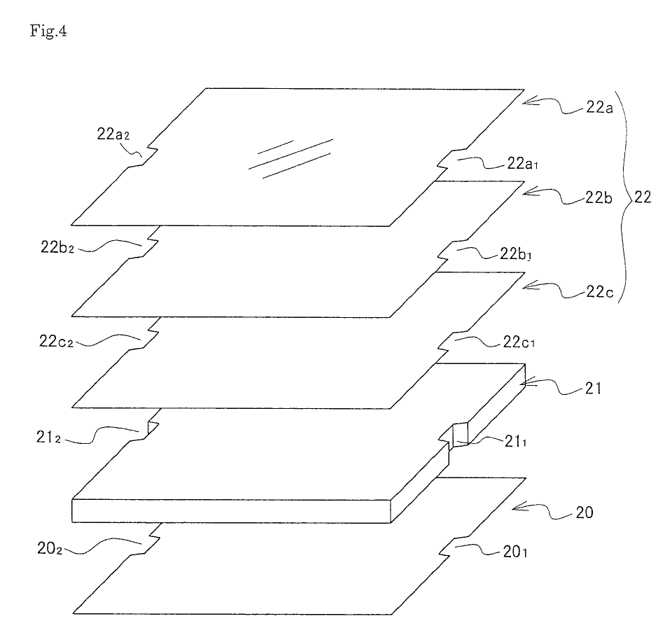

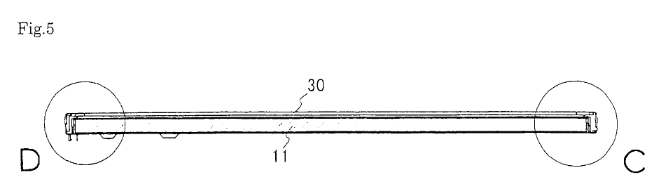

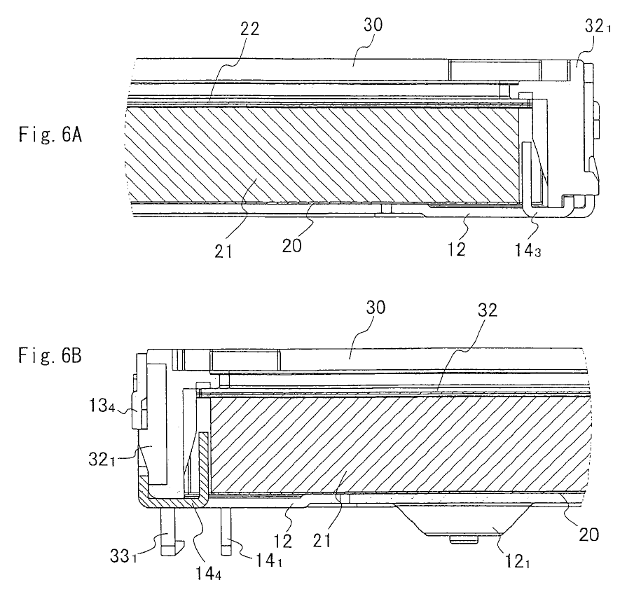

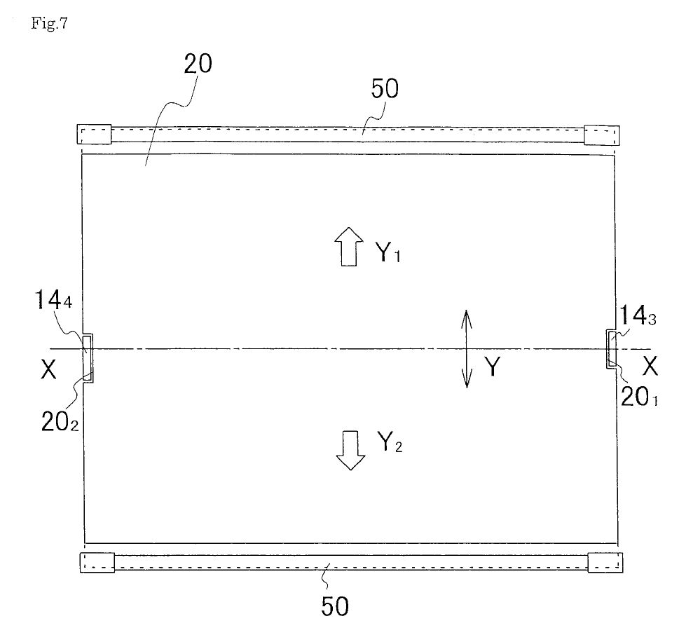

FIG. 1 is a plan view showing the lighting unit of the liquid crystal display of the present invention, FIG. 2 is a perspective view of the housing and chassis in FIG. 1 seen from the bottom, FIG. 3 is a plan view showing the housing, FIG. 4 is a perspective view showing the reflection sheet, light guide plate and optical sheets, FIG. 5 is a cross-sectional view on A-A in FIG. 1, FIG. 6 shows side edges of the liquid crystal display, FIGS. 6A and 6B being enlarged cross-sectional views of portions C and D respectively in FIG. 5, and FIG. 7 is a plan view showing the reflection sheet installed in the housing.

As shown in FIGS. 1 to 4, the lighting unit 10 is composed of two light sources, a light guide plate 21 that guides the light from the light sources, optical sheets 22 located on the obverse face of the light guide plate 21, a reflection sheet 20 located on the reverse face of the light guide plate 21, a housing 11 that encases the foregoing parts, and a chassis 30 that fits onto the opening-including edges of the housing 11. The light sources are omitted in FIGS. 1 to 4.

As shown in FIGS. 2 and 3, the housing 11 is equipped with a rectangular bottom wall 12 and sidewalls 13₁ to 13₄ that are bent around the periphery of the bottom wall and rise up to a certain height; the upper portion of the housing 11 takes the shape of an open, shallow-bottomed box and is formed by processing of sheet metal. This housing 11 is of a sufficient size to be able to house the reflection sheet 20, the light guide plate 21, the optical sheets 22 and other parts.

In the bottom wall 12 of the housing 11 are provided downward-projecting multiple protuberances 12₁, 12₂ and multiple cutout tabs 14₁, 14₂, as well as two upward-projecting cutout tabs 14₃, 14₄. The multiple protuberances 12₁, 12₂ are for keeping the liquid crystal display level when placed on a desk or other surface; all of the protuberances 12₁, 12₂ are of the same height. The multiple cutout tabs 14₁, 14₂, 14₃, 14₄ are formed by being cut from the bottom wall 12 and turned downward or upward. The cutout tabs 14₁, 14₂ are used for installing the housing 11 to other equipment, etc., while the cutout tabs 14₃, 14₄ are for supporting and/or fixing parts housed or installed within the housing 11.

Among the multiple cutout tabs 14₁, 14₂, 14₃, 14₄, the pair of opposed cutout tabs 14₃, 14₄ (referred to below as the first cutout tab and the second cutout tab) project in the direction of the inner surface of the bottom wall 12 and lie on a center line X-X that connects the center points 13′₃, 13′₄ of the opposed shorter-edge sidewalls 13₃, 13₄, being formed in positions close to each shorter-edge sidewall 13₃, 13₄.

The first cutout tab 14₃ is placed as the central portion 14′₃ of the cutout tab lies on the center line X-X, whereas the second cutout tab 14₄ is placed as 14′₄ is in a position removed from the center line X-X. Furthermore, the lengths of these cut-out portions 14₃, 14₄ differ, the first cutout tab 14₃ being short and the second cutout tab 14₄ being longer than the first cutout tab. These lengths of the first and second cutout tabs could equally well be reversed. Additionally, these cutout tabs 14₃, 14₄ are formed with heights that are smaller than the thickness of the light guide plate 21.

These cutout tabs 14₃, 14₄ are here formed as strips by processing of sheet metal, but are not limited to a strip shape; where the housing is formed as a molding of a resin material, for example, these cutout tabs 14₃, 14₄ might be formed as linear projections instead of strips. Furthermore, rather than being linear, such projections might be formed in any desired shape, such as circular or elliptical.

In each of the shorter-edge sidewalls 13₃, 13₄ there are formed multiple locking openings 15₁. These locking openings 15₁ engage with the locking bars of the chassis 30.

The chassis 30 covers the opening-including edges of the upper portion of the housing 11 so as to engage with the sidewalls, and fixes the reflection sheet 20, the light guide plate 21, the optical sheets 22 and other parts housed within the housing 11. The chassis is frame-shaped and is formed from synthetic resin.

The frame-shaped chassis 30 is made up of longer and shorter edges 30₁ to 30₄, all formed so as to be very narrow. Sidewalls 31₃, 31₄ of a particular height rise up on the opposed shorter edges 30₃ and 30₄ among these chassis edges 30₁ to 30₄, and in these sidewalls 31₃, 31₄ there are formed multiple locking bars 32₁.

As shown in FIG. 4, the light guide plate 21 consists of a rectangular plate-form body of a particular thickness that is formed from, for instance, translucent white acrylic resin material. The light guide plate's shape is a rectangle somewhat smaller in size than the housing 11, and in the light guide plate's opposed shorter-edge sidewalls, on which no light source is deployed, are formed flat-bottomed notches 21₁, 21₂(referred to below as the first and second flat-bottomed notches) that engage with the first and second cutout tabs 14₃, 14₄ formed in the bottom wall 12 of the housing 11. Accordingly, the first flat-bottomed notch 21₁ is located at the central portion of one shorter edge and has a short length so as to match the length of the first cutout tab 14₃, while the second flat-bottomed notch 21₂ is located approximately at the central portion of the other shorter edge and is formed to be long so as to match the length of the second cutout tab 14₄.

The reflection sheet 20 has the same shape as the light guide plate 21, is provided with flat-bottomed notches 20₁, 20₂ in the same positions and with the same shapes as the flat-bottomed notches 21₁, 21₂ of the light guide plate 21, and is formed from white-colored resin film having a high degree of reflectivity.

The optical sheets 22 are composed of multiple sheets 22a to 22c that include for example a diffusion sheet and a light-condensing sheet. All of the sheets 22a to 22c have the same shape as the light guide plate 21, and flat-bottomed notches 22a₁ and 22a₂, 22b₁ and 22b₂, and 22c₁ and 22c₂, respectively, are formed in the sheets 22a to 22c in the same positions and with the same shapes as the flat-bottomed notches 21₁, 21₂ of the light guide plate 21.

To assemble this lighting unit 10, the reflection sheet 20, light guide plate 21 and optical sheets 22 are laminated in that order inside the housing 11, with the reflection sheet 20 bottommost. In such process, the flat-bottomed notches 20₁, 20₂, 21₁, 21₂, etc., of the reflection sheet 20 and light guide plate 21 engage with the housing bottom wall's first and second cutout tabs 14₃, 14₄. Since the first and second cutout tabs 14₃, 14₄ have differing positions and lengths, there will be no errors in the obverse/reverse face and horizontal orientations of the reflection sheet and light guide plate when housed. That is, the lengths of the flat-bottomed notches 20₁, 20₂, 21₁, 21₂, etc., are determined so as to match the lengths of the first and second cutout tabs 14₃, 14₄, and hence it will not be possible to fit the cutout tabs into the flat-bottomed notches if any mistake is made in the horizontal or the obverse/reverse face orientations of the light guide plate and reflection sheet.

Next, the optical sheets 22 are mounted over the light guide plate 21 and the frame-shaped chassis 30 is fitted so as to press down on the outer edges, with the locking bars 32₁ of the chassis 30 engaging into the locking openings 15₁ in the housing 11, thus completing the assembly (refer to FIGS. 5, 6A and 6B)

With the lighting unit 10 thus assembled, two light sources 50 (for which see FIG. 7) are deployed along the longer edges of the light guide plate 21, a liquid crystal panel is mounted over the optical sheets 22, and the periphery of the liquid crystal panel is covered with a frame-shaped exterior rim, to complete the liquid crystal display. Descriptions of the light sources 50, liquid crystal panel and exterior rim are omitted here since commonly-known items are used for each.

FIG. 7 is a plan view showing the reflection sheet installed in the housing. In this installed state, the first and second flat-bottomed notches 20₁, 20₂ in the reflection sheet 20 are engaged with the first and second cutout tabs 14₃, 14₄ of the housing 11, and the reflection sheet 20 is fixed so that the center line connecting the opposed center points of its shorter edges is positioned on the center line X-X that connects the center points 13′₃, 13′₄ respectively of the light guide plate's opposed shorter-edge sidewalls 13₃, 13₄, on which no light source is deployed.

If the reflection sheet 20 in this fixed state expands by a particular length ΔY in the direction Y perpendicular to the center line X-X, due for example to a thermal cause, then Y₁=Y₂=ΔY/2 because the reflection sheet 20 is fixed on the center line X-X of the shorter-edge sidewalls 13₃, 13₄, and so Y₁ and Y₂ will each expand evenly by one half of ΔY. Supposing that the reflection sheet 20 were not fixed to the housing 11, there would be a biased expansion in one direction by the amount ΔY, and a proportionate space would open up in the other direction. Also if the reflection sheet 20 were fixed not on the center line X-X but in a position removed from the center line, the expansion in direction Y would not be even.

Thus, the reflection sheet 20 expands evenly in direction Y and therefore will not contact with the shorter-edge sidewalls 13₁, 13₂, etc., of the housing 11. Consequently, the localized concentration of stress that would result from such contacting is eliminated. Further, expansion in the direction of the center line X-X is accommodated by the formation of a certain clearance between the first and second flat-bottomed notches 20₁, 20₂ of the reflection sheet 20 and the first and second cutout tabs 14₃, 14₄ of the housing 11. As a result there will be no localized concentration of stress, and no occurrence of flexure or wrinkle, on the surface of the reflection sheet 20.

Since the light guide plate 21 is fixed by the same method as the reflection sheet 20, the light guide plate 21 will not be biased toward one of the sidewalls. In addition, linear light sources will normally be deployed on these sidewalls, permitting a short distance between the sidewalls and the light sources. Hence, a well-balanced layout is enabled.

1. A lighting unit comprising:
a housing having a rectangular bottom wall, wherein a locking projection that projects from said bottom wall is formed respectively at a pair of facing side edges of the housing;
a reflection sheet that has locking portions that lock with said locking projections;
a light guide plate that is laminated over said reflection sheet and has locking portions that lock with said locking projections; and
light sources deployed at both ends of said light guide plate;
and wherein said locking projections are formed on the center line that connects the center points of those of said light guide plate's edges on which no light source is deployed.

2. The lighting unit according to claim 1, wherein said locking projections are linear projections of a particular length that are parallel to the facing side edges.

3. The lighting unit according to claim 2, wherein one of said opposed linear projections is longer than the other.

4. The lighting unit according to claim 1, wherein the longitudinal center point of one of said opposed locking projections lies on said center line, while the other locking projection is formed with its longitudinal center point in a position removed from said center line.

5. A liquid crystal display comprising the lighting unit according to claims 1 and further comprising a liquid crystal panel that is located on the irradiating surface side of said lighting unit.
